(19) United States
(12) Patent Application Publication
(10) Pub. No.: US 2014/0279441 A1
(43) Pub. Date: Sep. 18, 2014

(54) SYSTEMS AND METHODS FOR SAVING A REMAINDER OF CASH TRANSACTIONS

(71) Applicant: Wal-Mart Stores, Inc., Bentonville, AR (US)

(72) Inventor: John K. Collier, Rogers, AR (US)

(73) Assignee: Wal-Mart Stores, Inc., Bentonville, AR (US)

(21) Appl. No.: 14/208,797

(22) Filed: Mar. 13, 2014

Related U.S. Application Data
(60) Provisional application No. 61/788,340, filed on Mar. 15, 2013.

(51) Int. Cl. G06Q 20/26

(52) U.S. Cl. CPC G06Q 20/26
USPC 705/39

(57) ABSTRACT

Exemplary embodiments are directed to systems, methods and non-transitory computer storage mediums for storage of a remainder of at least one cash transaction. The exemplary systems, methods and non-transitory computer storage mediums include an electronically stored consumer account, an electronic payment terminal, and a transaction processing system. The transaction processing system is communicatively linked to the consumer account and the electronic payment terminal for directing saving a value of the remainder of the at least one cash transaction from the electronic payment terminal to the consumer account. Exemplary embodiments are further directed to methods of storing a remainder of at least one cash transaction and non-transitory computer readable medium storing instructions for a processing device for implementing the exemplary methods.

### CROSS-REFERENCE TO RELATED APPLICATIONS

The present application claims the benefit of priority of U.S. provisional patent application entitled “Systems and Methods for Saving a Remainder of Cash Transactions,” which was filed on Mar. 15, 2013, and assigned Ser. No. 61/788,340. The entire content of the foregoing provisional application is incorporated herein by reference.

### TECHNICAL FIELD

The present disclosure relates to systems, methods and non-transitory computer storage media for saving a remainder of cash transactions and, in particular, to e-commerce systems, methods and non-transitory computer storage media for saving and storing a remainder of cash transactions in a non-cash format for subsequent use by a consumer.

### BACKGROUND

Conventionally, when a consumer pays for goods or services with cash, change is due back to the consumer from the seller, e.g., a store, restaurant, and the like. For example, when a consumer purchases an item having a purchase price of $4.55 by tendering $5.00 to the seller, the seller is obligated to return the excess change, e.g., $0.45, to the consumer. The excess change can be a burden on both the seller and the consumer.

With respect to the seller, coins for change must be counted or reconciled, or both, for each point of sale (POS) register. In addition, sellers may require end-of-shift coin counting at each POS register, thereby adding unnecessary overhead costs. Once collected, coins are transported to and from a seller by an armored vehicle, further increasing overhead expenses.

With respect to the consumer, when change is received after a purchase, the consumer is obligated to carry the coins or leave them as a “tip” to the seller. The excess change carried by the consumer can be, e.g., lost or misplaced, stolen, lost to circulation, and the like, and requires the consumer to manage the coins after leaving the seller. The excess change may also be deposited by the consumer into a personal “piggy bank”, where the consumer will likely leave the change and forget to use it in the future. Similarly, to minimize the amount of change carried, the consumer may decide to leave the excess change with the seller. Thus, over time, the consumer can potentially lose a large amount of money due to the inconvenience of excess change resulting from cash purchases.

### SUMMARY

In accordance with embodiments of the present disclosure, exemplary point of sale systems for storage of a remainder of at least one cash transaction are provided. In particular, the systems include an electronically stored consumer account, an electronic payment terminal, and a transaction processing system. The transaction processing system is communicatively, e.g., electronically, linked to the consumer account and the electronic payment terminal for saving a value of the remainder of the at least one cash transaction from the electronic payment terminal to the consumer account. The transaction processing system also communicatively links the consumer account to the electronic payment terminal.

The electronic payment terminal, e.g., a cash register, includes entry means such as a keyboard, a mouse, a graphical user interface, a card reader, and the like. The consumer identifier is at least one of, e.g., a numeric identifier, an alphanumeric identifier, a telephone number, a social security number, a consumer photograph, and the like, and is unique to each consumer or consumer family, or both.

The transaction processing system directs the transfer of the remainder of the at least one cash transaction from the electronic payment terminal to the consumer account based on an association between the consumer account and the consumer identifier. The transaction processing system further retrieves an accumulated remainder, e.g., at least part of the balance in the consumer account, from the consumer account for use by a consumer during a subsequent purchase. For example, the accumulated remainder can be a full accumulated remainder amount or a partial accumulated remainder amount retrieved from the consumer account. In some embodiments, the retrieved accumulated remainder is retrieved by the transaction processing system during the subsequent purchase to at least partially reduce a purchase amount. In some embodiments, the partial accumulated remainder amount is retrieved by the transaction processing system during the subsequent purchase to reduce a purchase amount to a full dollar amount, thus providing the consumer with full dollar amount change.

In accordance with embodiments of the present disclosure, exemplary methods of storing a remainder of at least one cash transaction in a point of sale system are provided. The methods include associating a consumer with an electronically stored consumer account and accepting a cash payment by the consumer at an electronic payment terminal. The methods further include directing, via a transaction processing system, storage of a value of the remainder of the cash payment from the electronic payment terminal to the consumer account.

Associating the consumer with the consumer account includes associating the consumer with a unique consumer identifier. The methods include directing a transfer of the remainder of the payment from the electronic payment terminal to the consumer account based on an association between the consumer account and the consumer identifier. The methods further include retrieving the accumulated remainder, e.g., the balance in the consumer account, from the consumer account for use by the consumer during a subsequent purchase. In some embodiments, retrieving the accumulated remainder from the consumer account includes retrieving a full accumulated remainder amount from the consumer account. In some embodiments, retrieving the accumulated remainder form the consumer account includes retrieving a partial accumulated remainder amount from the consumer account.

In accordance with embodiments of the present disclosure, exemplary non-transitory computer readable media storing instructions are provided. Execution of the instructions by a processing device causes the processing device to implement a method which includes associating a consumer with an electronically stored consumer account. The method also includes accepting a payment by the consumer at an electronic payment terminal. The method further includes directing, via a transaction processing system, storage of a value of a remainder of the payment from the electronic payment terminal to the consumer account.

Associating the consumer with the consumer account can include associating the consumer with a consumer identifier. The media can include instructions for directing a transfer of the remainder of the payment from the electronic payment terminal to the consumer account based on an association between the consumer account and the consumer identifier. The media can include instructions for retrieving an accumulated remainder from the consumer account for use by the consumer during a subsequent purchase. The retrieved accumulated remainder is one of a full accumulated remainder amount or a partial accumulated remainder amount.

The exemplary systems, methods and non-transitory computer readable media provide consumers with ways to store excess change received after a cash purchase for subsequent use and advantageously provide for a more efficient and faster consumer checkout time. In addition, the systems and methods act as a marketing opportunity for businesses by encouraging consumers to return to specific establishments to use the stored and accumulated excess change, while reducing overhead expenses for, e.g., coin storage, coin transportation, account reconciliation, and the like.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed systems and methods, reference is made to the accompanying figures, wherein:

FIG. 1 is a block diagram of an exemplary system according to the present disclosure;

FIG. 2 is a block diagram of an exemplary computing device configured to implement embodiments of the exemplary systems and methods;

FIG. 3 is an exemplary computing system for implementing embodiments of the exemplary systems and methods;

FIG. 4 is a flowchart of an exemplary system for holding change due in a consumer account according to the present disclosure;

FIG. 5 is a flowchart of an exemplary system for applying change stored in a consumer account to a purchase according to the present disclosure; and

FIG. 6 is a flowchart of an alternative exemplary system according to the present disclosure.

### DESCRIPTION OF EXEMPLARY EMBODIMENTS

With reference to FIG. 1, a block diagram of an exemplary point of sale system 100 (hereinafter “system 100”) for performing cash transactions is provided. The system 100 includes a programmable or configurable, or both, consumer account module 102 for managing and storing a plurality of consumer accounts 104. Each consumer account 104 is associated with a consumer, e.g., an individual consumer, an entire family, and the like. In some embodiments, the consumer accounts 104 can be in the form of, e.g., electronic data files, one or more memory locations, one or more records in a database, a relational database, and the like. The consumer accounts 104 are further associated with unique consumer identifiers 106, e.g., a numeric identifier, an alphanumeric identifier, a telephone number, a social security number, a consumer photograph, and the like. However, it should be understood that alternative unique consumer identifiers 106 can be used.

The system 100 includes a transaction processing system 108 and a programmable and configurable, or both, electronic payment terminal module 110. The electronic payment terminal module 110 is electronically connectable to a plurality of electronic payment terminals 112, e.g., cash registers, and the like. For example, the electronic payment terminal module 110 can be electronically connected to a plurality of electronic payment terminals 112 over a communication network. Although shown as having two electronic payment terminals 112, in some embodiments, the seller can have, e.g., one, two, three, four, five, six, seven, and even more electronic payment terminals 112.

The transaction processing system 108 communicatively, e.g., electronically, links the consumer account module 102 and the electronic payment terminal module 110 over a communication network 114. Although shown in FIG. 1 as a separate component from the consumer account module 102 and the electronic payment terminal module 110, in some embodiments, the transaction processing system 108 can be combined with or incorporated into, e.g., the consumer account module 102, the electronic payment terminal module 110, and the like. In some embodiments, the transaction processing system 108 communicatively links the individual consumer accounts 104 with the specific electronic payment terminal 112 being utilized to perform the cash transaction. In some embodiments, the transaction processing system 108 can be located at each of the electronic payment terminals 112. Thus, a cash transaction between a consumer and a seller, e.g., a store, can take place at an electronic payment terminal 112 and the transaction processing system 108 communicatively links the electronic payment terminal 112 with the appropriate consumer account 104 based on the consumer identifier 106 for the consumer making the purchase. For example, the consumer identifier 106 can take the form of a loyalty or rewards card which can be scanned or swiped, or both, to retrieve information regarding the consumer account 104 at the electronic payment terminal 112.

Turning now to FIG. 2, a block diagram of an exemplary processing or computing device 200 (hereinafter “computing device 200”), e.g., the transaction processing system 108, programmed or configured, or both, to implement embodiments of the system 100 is provided. The computing device 200 can be a mainframe, electronic cash register, personal computer (PC), laptop computer, workstation, server, handheld device, such as a portable digital assistant (PDA), and the like. In the illustrated embodiment, the computing device 200 includes a processing device 202, such as a central processing unit, and can include storage 204, e.g., electronic data storage. The computing device 200 can further include input/output devices 206, such as a display device, keyboard, touch screen, mouse, printer, card reader or scanner, and the like, and can include a network interface 208 (wired or wireless interface) to facilitate communication between the computing device 200 and other devices communicatively coupled to a communication network.

The storage 204 stores data and instructions and can be implemented using non-transitory computer readable medium technologies, such as a floppy drive, hard drive, tape drive, solid state storage devices, Flash drive, optical drive, read only memory (ROM), random access memory (RAM), and the like. For example, the storage 204 can store information regarding consumer accounts 104, such as consumer identifiers 106, consumer account balances, and the like. In some embodiments, the information stored on the storage 204 with respect to the consumer accounts 104 can be in the form of, e.g., electronic data files, one or more memory locations, one or more records in a database, a relational database, and the like. Applications, such as an embodiment of the transaction processing system 108, or portions thereof, can be resident in the storage 204 and can include instructions for implementing the applications. The storage 204 can be local or remote to the computing device 200. The processing device 202 operates to execute the applications in storage 204, such as the transaction processing system 108, by executing instructions therein and storing data resulting from the executed instructions, which may be presented via, for example, a graphical user interface (GUI) associated with or independent from the electronic payment terminal 112.

FIG. 3 is a block diagram of an exemplary computing system 300 configured to implement one or more embodiments of the system 100. The computing system 300 includes servers 302-306 operatively coupled to clients 308-312 (e.g., consumers, sellers, and the like), via a communication network 314, which can be any network over which information can be transmitted between devices communicatively coupled to the communication network 314. For example, the communication network 314 can be the Internet, Intranet, virtual private network (VPN), wide area network (WAN), local area network (LAN), wireless communication means, and the like. The computing system 300 can include repositories, e.g., storage or databases 316-320, which can be operatively coupled to the servers 302-306, as well as to clients 308-312, via the communications network 314. The servers 302-306, clients 308-312 and databases 316-320 can be implemented as computing devices. Those skilled in the art will recognize that the databases 316-320 can be incorporated into one or more of the servers 302-306 such that one or more of the servers 302-306 can include databases 316-320.

In some embodiments, the system 100 can be distributed among different devices (e.g., servers, clients, databases) in the communication network 314 such that one or more components of the system 100, or portions thereof, can be implemented by different devices in the communication network 314. As one example, in illustrative embodiments, the consumer account module 102, or portions thereof, can be implemented by the server 302, the electronic payment terminal module 110, or portions thereof, can be implemented by the server 304, and the transaction processing system 108 can be implemented by the server 306. As another example, servers 302-306 can be configured to host consumer accounts 104. Clients 308-312 can represent a seller having an electronic payment terminal 112 for performing cash transactions between the seller and the consumer. The databases 316-320 can be configured to store information regarding the consumer accounts 104, such as consumer identifiers 106, consumer account balances, and the like. In some embodiments, the databases 316-320 can be configured to store information regarding the consumer accounts 104 in the form of, e.g., electronic data files, one or more memory locations, records in the databases 316-320, and the like.

Turning now to FIG. 4, a flowchart for an exemplary system 100 for holding change due in a consumer account 104 is provided. In particular, when a consumer is ready to complete a cash purchase at a seller location, e.g., a store, a cashier or an automated POS system (e.g., a self-checkout kiosk) can be used to scan or enter the merchandise price(s) into the POS terminal, e.g., the electronic payment terminal 112 (step 400). The POS terminal then displays the total monetary amount due by the consumer (step 402). To pay for the goods or services, the consumer can provide the cashier or automated POS system with the necessary cash payment to cover the purchase (step 404). When the consumer has previously made purchases through the system 100 at the seller location, the cashier or automated POS system can be utilized to look up, identify and retrieve the consumer account 104 associated with the consumer identifier 106 provided by the consumer making the purchase (step 406). Therefore, in some embodiments, system 100 includes a graphical user interface for entering a consumer identifier 106 and retrieving the associated consumer account 104 and account information. In some embodiments, a scanner, camera, proximity reader, or combinations thereof can be utilized to retrieve or enter, or both, the consumer identifier 106 and retrieve the associated consumer account 104 and account information. Thus, if the consumer has a consumer account 104 with a monetary balance accumulated from at least one previous purchase, the cashier or automated POS system can retrieve the consumer account 104 balance and optionally utilize a portion or all of the balance toward payment of the current purchase by the consumer.

Further, the cashier enters or the automated POS system receives, or both, the cash payment provided by the consumer (step 404). The cashier or the automated POS system can then indicate the total change due, e.g., the remainder, to the consumer, if any (step 408). With respect to cash payments by the consumer, the change owed is any monetary amount provided by the consumer which exceeds the total purchase price. For example, if the total purchase price is $4.50 and the consumer makes a cash payment of $5.00, the consumer would be owed change of $0.50. As a further example, if the total purchase price is $7.50 and the consumer makes a cash payment of $10.00, the consumer would be owed change of $2.50.

The automated POS system or the cashier, or both, can then ask the consumer whether the consumer will allow the seller or would like to hold the change for subsequent purchases or whether the consumer will keep the change (step 410). In the second example above, the consumer can decide whether the change is the full $2.50, part of the $2.50, or just $0.50. If the consumer does not plan on returning to the particular store location or other participating seller locations, the consumer can request the change due and the change is presented to the consumer (step 420). In some embodiments, the system 100 can be implemented by a plurality of sellers and, therefore, the consumer account 104 can be accessed at a variety of different store locations, online via a web-site of the seller for online transactions, or both. Once the consumer receives the excess change, a receipt can be printed to indicate the total amount paid and the change received (step 418).

On the other hand, if the consumer wishes to allow the seller to hold the excess change due for a subsequent purchase, the consumer identifier 106 can be entered into the POS system to associate the consumer with the consumer identifier 106, the consumer account 104, or both (step 412). If the consumer does not have a consumer account 104, the POS system can create a new consumer account 104 associated with either an automatically generated or consumer selected consumer identifier 106, e.g., a numerical identifier, an alphanumeric identifier, a physical card provided to the consumer with a bar code representing the consumer identifier or account, a telephone number, a social security number, a consumer photograph, or any other suitable form of secure identification of the consumer.

Once the consumer has been associated with the consumer identifier 106, the consumer account 104, or both, the excess change due can be associated with the consumer identifier 106, the consumer account 104, or both (step 414). The excess change, e.g., the remainder of $0.50 from the example above, is then stored in the consumer account 104 and accumulated in the consumer account 104 until the consumer decides to retrieve the accumulated monetary amount to be applied to a subsequent purchase by the consumer (step 416). The transaction between the consumer and the seller through the system 100 is thereby completed and a receipt can be printed to show the total amount paid and, in some embodiments, the change applied to the consumer account 104 or the balance of the consumer account 104, or both (step 418). Thus, the system 100 creates an efficient checkout time for the consumer by omitting the necessity for retrieving and counting the excess change to be returned to the consumer.

Turning now to FIG. 5, a flowchart for an exemplary system 100 for applying change stored in a consumer account 104 to a purchase is provided. Similar to the flowchart of FIG. 4, when a consumer is ready to complete a cash purchase at a seller location, e.g., a store, a cashier or an automated POS system (e.g., a self-checkout kiosk) can be used to scan or enter the merchandise price(s) into the POS terminal, e.g., the electronic payment terminal 112 (step 500). The POS terminal then displays the total monetary amount due by the consumer (step 502). When the consumer has previously made purchases through the system 100 at the seller location, the cashier or automated POS system can be utilized to look up, identify and retrieve the consumer account 104 associated with the consumer identifier 106 provided by the consumer making the purchase (step 504). Therefore, in some embodiments, system 100 includes a graphical user interface for entering a consumer identifier 106 and retrieving the associated consumer account 104 and account information. In some embodiments, a scanner, camera, proximity reader, or combinations thereof can be utilized to retrieve or enter, or both, the consumer identifier 106 and retrieve the associated consumer account 104 and account information. Thus, if the consumer has a consumer account 104 with a monetary balance accumulated from at least one previous purchase, the cashier or automated POS system can retrieve the consumer account 104 balance and optionally utilize a portion or all of the balance toward payment of the current purchase by the consumer.

The cashier or the POS terminal, or both, can then ask the consumer if the seller is allowed or if the consumer would like to apply at least a portion of the previously stored remainder, e.g., the accumulated balance in the consumer account 104, to the current purchase (step 506). If the consumer declines to apply the previously stored remainder, the consumer can provide the cashier or the automated POS system with the necessary cash payment to cover the purchase price (step 516). The cashier or the automatic POS system can then indicate the total change due, e.g., the remainder, to the consumer, if any (step 518). With respect to cash payments by the consumer, the change owed is any monetary amount provided by the consumer which exceeds the total purchase price. For example, if the total purchase price is $4.50 and the consumer makes a cash payment of $5.00, the consumer would be owed change of $0.50. As a further example, if the total purchase price is $7.50 and the consumer makes a cash payment of $10.00, the consumer would be owed change of $2.50.

Optionally, after indicating the total change due, the automated POS system or the cashier, or both, can ask the consumer whether the consumer will allow the seller to hold the change for subsequent purchases or whether the consumer will keep the change (see, e.g., FIG. 4, step 410). If the consumer wishes to allow the seller to hold at least a portion of the excess change due for a subsequent purchase, steps 408-416 of FIG. 4 can be followed. On the other hand, if the consumer wishes to receive the change due, the consumer can request the change due and the change is presented to the consumer (step 520). Once the consumer receives the excess change, a receipt can be printed to indicate the total amount paid and the change received (step 514).

However, if the consumer agrees to apply at least a portion of the stored remainder in the consumer account 104 towards the current purchase, the consumer can be associated with a consumer identifier 106 (step 508). At least a portion of the change stored in the consumer account 104 can then be applied to the total amount due (step 510). The balance of the consumer account 104 can then be updated based on the change retrieved for the purchase (step 512) and a receipt can be printed (step 514).

If the remainder amount applied to the current purchase does not cover the full purchase price, the consumer can provide the cashier or the automated POS system with the necessary cash payment to cover the purchase price (step 516). For example, if the total amount due is $8.50 and the remainder in the consumer account 104 or the portion of the remainder in the consumer account 104 to be applied to the current purchase is $5.00, the consumer can be asked to provide the necessary cash payment for the remaining $3.50 balance due. Once the cash payment to cover the remaining balance due has been provided, the cashier or the automated POS can then indicate the total change due, e.g., the remainder, to the consumer, if any (step 518). Optionally, after indicating the total change due, the automated POS system or the cashier, or both, can ask the consumer whether the consumer will allow the seller to hold the change for subsequent purchases or whether the consumer will keep the change (see, e.g., FIG. 4, step 410). If the consumer wishes to allow the seller to hold at least a portion of the excess change due for a subsequent purchase, steps 408-416 of FIG. 4 can be followed. On the other hand, if the consumer wishes to receive the change due, the consumer can request the change due and the change is presented to the consumer (step 520). Once the consumer receives the excess change, a receipt can be printed to indicate the total amount paid and the change received (step 514).

In some embodiments, the portion of the change stored in the consumer account 104 applied toward the total amount due reduces the total due to the next full dollar amount. For example, if the total amount due is $8.50, $0.50, if available in the consumer account 104, can be retrieved and applied toward the total amount due to reduce the amount owed by the consumer to an even dollar amount, e.g., $8.00. Thus, if the consumer pays with $10.00, rather than receiving $1.00 and change in return, the consumer can receive a full dollar amount, e.g., $2.00. It should be understood that in some embodiments, if the consumer decides to apply at least a portion of the accumulated change in the consumer account 104 towards the current purchase, the consumer can decide to allow the seller to hold any change due for a subsequent purchase. For example, as described above, if the total amount due is $8.50, $0.50 has been retrieved from the consumer account 104 and applied to the total amount due, and the consumer pays with $10.00, the remainder, e.g., $2.00, can either be returned to the consumer or the consumer can decide to store the remainder (e.g., $2.00) in the consumer account 104 for a subsequent purchase. Thus, the system 100 creates an efficient checkout time for the consumer by omitting the necessity for retrieving and counting the excess change to be returned to the consumer, and by allowing the consumer to pay for at least a portion of a purchase with a preexisting balance in a consumer account 104.

In some embodiments, instead of a cash transaction, other monetary transactions can take place. For example, with reference to FIG. 5, a flowchart of an exemplary system 100 for non-cash payments, e.g., credit card, check, money order, debit card payments, and the like, by the consumer is provided. In particular, when a consumer is ready to complete a purchase at a seller location, e.g., a store, a cashier or an automated POS system can be used to scan or enter the merchandise price(s) into the POS terminal, e.g., the electronic payment terminal 112 (step 600). The POS terminal can then display the total monetary amount due, the total monetary amount due and the excess change due, e.g., remainder, due if the total monetary amount due is rounded to the next full dollar amount, the total monetary amount due and the excess change due if at least a portion of the change stored in the consumer account 104 is applied toward the current purchase, or combinations thereof (step 602). For example, if the total amount due is $4.50 and the consumer wishes to make an electronic payment, e.g., a credit card payment, the POS terminal can display the total amount due ($4.50), the total amount due if rounded to the next full dollar amount ($5.00) and the excess change to be charged to the electronic payment ($0.50), the total amount due if at least a portion of the change stored in the consumer account 104 (e.g., $0.50) is applied toward the current purchase to reduce the total amount due to the next full dollar amount ($4.00), or combinations thereof.

In some embodiments, the cashier or the POS terminal, or both, can then ask the consumer whether the consumer will allow the seller to hold the excess change for a subsequent purchase (step 604). In some embodiments, at step 602, the POS terminal can display only the total amount due and, at step 604, the cashier or the POS terminal, or both, can ask the consumer whether the consumer will allow the seller to round the total amount due to the next full dollar amount and hold the excess change in the consumer account 104 for a subsequent purchase. If the consumer agrees to allow the seller to round the total amount due to the next full dollar amount and hold the excess change in the consumer account 104, the POS terminal can automatically round the total amount due to the next full dollar amount (step 606).

If the consumer does not desire to round the total amount due to the next full dollar amount and wishes to charge only the original total amount due, the cashier or the POS terminal, or both can charge the original total amount due (step 616). The transaction between the consumer and the seller is thereby complete and a receipt can be printed to indicate the total amount charged (step 614).

On the other hand, if the consumer allows the seller to round the total amount due to the next full dollar amount and hold the excess change in the consumer account 104 for a subsequent purchase, the rounded payment amount can be entered manually or automatically into the POS terminal (step 606). If the consumer wishes to apply a previously accumulated balance from a consumer account 104 toward all or part of the purchase, the cashier or the POS terminal, or both, can receive the consumer identifier 106 provided by the consumer to determine the account balance or the amount to be applied to the current purchase, or both (step 606). The consumer can then be associated with the consumer account 104 or the consumer identifier 106, or both, provided by the consumer (step 608). If the consumer does not have a consumer account 104, the POS terminal can automatically create a consumer account 104 and associate the consumer account 104 with a unique consumer identifier 106. The excess change is then associated with the consumer account 104 or the consumer identifier 106, or both (step 610). Further, the excess change, e.g., the remainder of $0.50 from the example above, is stored in the consumer account 104 and accumulated until the consumer desires to utilize the accumulated remainder monetary balance for a subsequent purchase (step 612). The transaction between the consumer and the seller through the system 100 is thereby completed and the POS terminal can be utilized to print a receipt showing the total amount due, the total rounded amount charged, the excess change charged and stored in the consumer account 104, or combinations thereof (step 614).

In some embodiments, following step 602, the consumer can be asked by the cashier or the POS terminal, or both, whether the seller is allowed or if the consumer would like to apply at least a portion of the change stored in the consumer account 104 towards the current purchase, e.g., to reduce the total amount due to the next full dollar amount (step 618). If the consumer does not allow the seller to apply the accumulated change to the current purchase, the original total amount due can be charged (step 616) and a receipt can be printed (step 614). However, if the consumer allows the seller to apply at least a portion of the accumulated change in the consumer account 104 towards the current purchase, the consumer can be associated with a consumer identifier 106 or consumer account 104, or both (step 620). At least a portion of the accumulated change can then be applied to the total amount due (step 622). For example, if the total amount due is $8.50, $0.50, if available in the consumer account 104, can be applied to the total amount due to reduce the total amount due to the next full dollar amount, e.g., $8.00. The consumer account 104 balance can then be updated to reflect the retrieved change (step 624) and the rounded total amount due can be charged (step 626). A receipt can then be printed to reflect the details of the purchase, including, in some embodiments, the consumer account 104 balance (step 628).

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A point of sale system for storage of a remainder of at least one cash transaction, the system comprising:
an electronically stored consumer account,
an electronic payment terminal, and
a transaction processing system communicatively linked to the consumer account and the electronic payment terminal for saving a value of the remainder of the at least one cash transaction from the electronic payment terminal to the consumer account.

2. The point of sale system according to claim 1, wherein the electronic payment terminal includes an entry means.

3. The point of sale system according to claim 1, wherein the consumer account is associated with a consumer identifier.

4. The point of sale system according to claim 3, wherein the consumer identifier is at least one of a numeric identifier, an alphanumeric identifier, a telephone number, a social security number, and a consumer photograph.

5. The point of sale system according to claim 3, wherein the transaction processing system directs a transfer of the remainder of the at least one cash transaction from the electronic payment terminal to the consumer account based on an association between the consumer account and the consumer identifier.

6. The point of sale system according to claim 1, wherein the transaction processing system retrieves an accumulated remainder from the consumer account for use by a consumer during a subsequent purchase.

7. The point of sale system according to claim 6, wherein the retrieved accumulated remainder is one of a full accumulated remainder amount or a partial accumulated remainder amount.

8. The point of sale system according to claim 7, wherein the partial accumulated remainder amount is retrieved by the transaction processing system during the subsequent purchase to reduce a purchase amount to a full dollar amount.

9. The point of sale system according to claim 6, wherein the retrieved accumulated remainder is retrieved by the transaction processing system during the subsequent purchase to reduce a purchase amount.

10. In a point of sale system, a method of storing a remainder of at least one cash transaction, the method comprising:
associating a consumer with an electronically stored consumer account,
accepting a payment by the consumer at an electronic payment terminal, and
directing, via a transaction processing system, storage of a value of the remainder of the payment from the electronic payment terminal to the consumer account.

11. The method according to claim 10, wherein associating the consumer with the consumer account comprises associating the consumer with a consumer identifier.

12. The method according to claim 11, comprising directing a transfer of the remainder of the payment from the electronic payment terminal to the consumer account based on an association between the consumer account and the consumer identifier.

13. The method according to claim 10, comprising retrieving an accumulated remainder from the consumer account for use by the consumer during a subsequent purchase.

14. The method according to claim 13, wherein retrieving the accumulated remainder from the consumer account comprises retrieving a full accumulated remainder amount from the consumer account.

15. The method according to claim 13, wherein retrieving the accumulated remainder from the consumer account comprises retrieving a partial accumulated remainder amount from the consumer account.

16. A non-transitory computer readable medium storing instructions, wherein execution of the instructions by a processing device causes the processing device to implement a method, comprising:
associating a consumer with an electronically stored consumer account,
accepting a payment by the consumer at an electronic payment terminal, and
directing, via a transaction processing system, storage of a value of a remainder of the payment from the electronic payment terminal to the consumer account.

17. The medium according to claim 16, wherein associating the consumer with the consumer account comprises associating the consumer with a consumer identifier.

18. The medium according to claim 17, comprising instructions for directing a transfer of the remainder of the payment from the electronic payment terminal to the consumer account based on an association between the consumer account and the consumer identifier.

19. The medium according to claim 16, comprising instructions for retrieving an accumulated remainder from the consumer account for use by the consumer during a subsequent purchase.

20. The medium according to claim 19, wherein the retrieved accumulated remainder is one of a full accumulated remainder amount or a partial accumulated remainder amount.
